(19) United States
(12) Patent Application Publication
(10) Pub. No.: US 2019/0080379 A1
(43) Pub. Date: Mar. 14, 2019

(54) SYSTEMS AND METHODS FOR DISTRIBUTED ACQUISITIONS

(71) Applicant: Walmart Apollo, LLC, Bentonville, AR (US)

(72) Inventors: Patricia Ann Marie Dallahan, Fremont, CA (US); Bey Mick Angeli, San Francisco, CA (US)

(21) Appl. No.: 16/127,117

(22) Filed: Sep. 10, 2018

Related U.S. Application Data
(60) Provisional application No. 62/556,457, filed on Sep. 10, 2017.

(51) Int. Cl. G06Q 30/06; G06Q 30/04

(52) U.S. Cl. CPC G06Q 30/0607; G06Q 30/0603; G06Q 30/0619; G06Q 30/04; G06Q 30/0643; G06Q 30/0639; G06Q 30/0637

(57) ABSTRACT

Systems and methods for distributed acquisitions associated with receiving item information and provide estimated landed costs for multiple countries and a large number of items. The system further aggregates item information from predefined websites and databases located globally and provides a global classification to classify items located in regions throughout the world to connect buyers with sellers.

### CROSS-REFERENCE TO RELATED PATENT APPLICATIONS

This application claims priority to U.S. Provisional Application No. 62/556,457, filed on Sep. 10, 2017, the content of which is hereby incorporated by reference in its entirety

### BACKGROUND

Items sold as consumer products may be manufactured in many geographically distinct locations. Furthermore these manufacturing sources may be located in different countries in addition to being separated by distance. Each country of origin of a consumer product may have different rules, regulations, and constraints affecting the transport and/or sale of the consumer product. Similarly, the destination country may have similar rules, regulations and/or constraints affecting the acquisition of the consumer product.

### BRIEF DESCRIPTION OF THE DRAWINGS

The accompanying drawings, which are incorporated in and constitute a part of this specification, illustrate one or more embodiments and, together with the description, help to explain the embodiments. The embodiments are illustrated by way of example and should not be construed to limit the present disclosure. In the drawings:

FIG. 1 is an exemplary networked environment for distributed acquisitions, in accordance with embodiments of the present disclosure;

FIG. 2 is an exemplary architecture of a computing system for distributed acquisitions, in accordance with an exemplary embodiment;

FIG. 3 illustrates a method to create a list of one or more items, in accordance with embodiments of the present disclosure;

FIG. 4 illustrates a buyer acquisition user interface for an exemplary website, in accordance with embodiments of the present disclosure;

FIG. 5 illustrates a buyer acquisition user interface for an exemplary item webpage, in accordance with embodiments of the present disclosure;

FIG. 6 illustrates a buyer acquisition user interface for an exemplary list webpage, in accordance with embodiments of the present disclosure;

FIGS. 7a and 7b illustrate a buyer acquisition user interface for an administration screen, in accordance with embodiments of the present disclosure;

FIG. 8 is a block diagram of an exemplary computing device that can be used to perform one or more steps of the methods provided by exemplary embodiments;

FIG. 9 illustrates a process for creating three dimensional virtual items, in accordance with an exemplary embodiment;

FIG. 10 illustrates a communications interface, in accordance with an exemplary embodiment; and

FIG. 11 illustrates an option window for adding items directly to the data catalog, in accordance with an exemplary embodiment.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

Systems and methods are described herein for distributed acquisitions. In one exemplary embodiment, a system includes a catalog database and at least one processor communicatively coupled to store websites and databases associated with various geographical locations. For example, a store website may be associated with selling items within the United States or a European country. The at least one processor executes a retrieval module (which may include the extraction, transformation, and loading (ETL) management unit discussed below) that obtains item information from the store websites and databases. The ETL management unit stores the item information into the catalog database. The item information may include but is not limited to, information regarding the original price of items, available item quantities, item sizes, item identifiers (i.e., IDs, SKUs, UPC, etc.), transportation costs, custom fees, duties, taxes and currency conversion rates based on an indicated destination, a geographic origin of the items and a country of origin of the items, and all transportation fees (including both inland and ocean related fees). In some embodiments, the item information may also include information regarding insurance, crating, handling, and/or payment fees.

The system also includes a buyer acquisition user interface executing on a computing device that is communicatively coupled to a rules engine. The buyer acquisition user interface is configured to display item information from the catalog database. The rules engine is configured to apply predefined rules to the item information to calculate landed costs for items delivered to a user-indicated destination. The landed costs represent a more complete cost of acquiring an item than the nominal price of the item as it includes additional costs involved with transporting the item from a geographically remote location to a designated destination.

For example, in an exemplary embodiment, the ETL management unit retrieves item information from a store database, where the item information includes at least one item associated with a unit price for the item. The rules engine then applies, for example, transportation costs, custom fees, duties, taxes and currency conversion rates to the unit price to obtain the landed cost for the item based on the indicated destination, a geographic origin of the item, and/or a country of origin of the item.

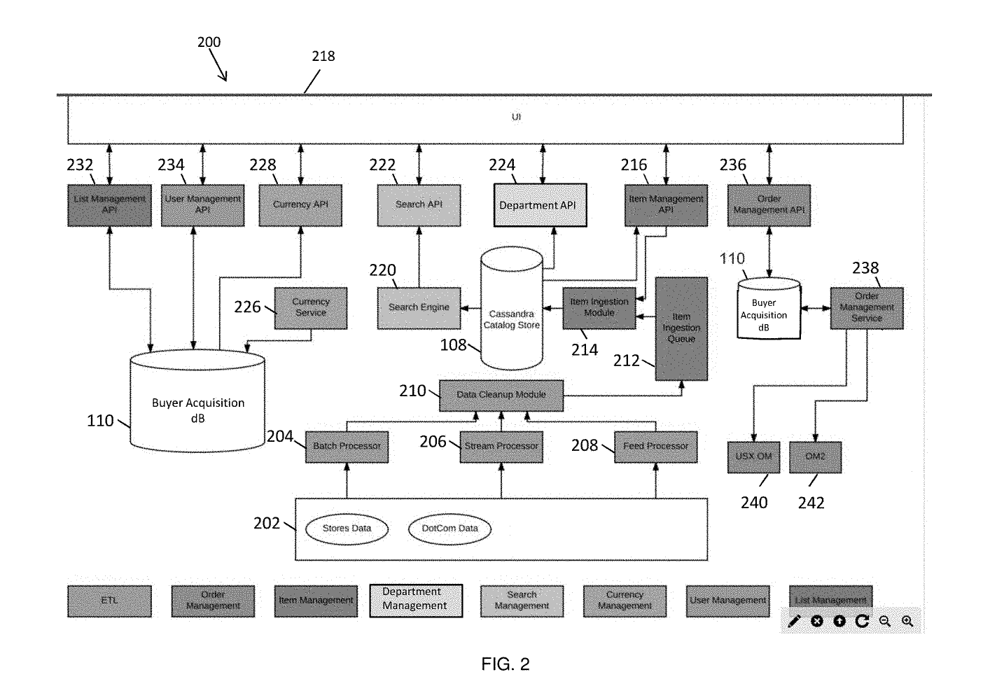

The rules engine may further identify items that are not able to be sold in particular countries or regions, for example, due to rules, regulations, and/or constraints. For example, rules may be originated by an entity considering the acquisition, regulations may be promulgated by a government authority, and constraints may be predefined restrictions prohibiting or limiting certain types of transactions set by an acquiring entity, a shipper, a manufacturer, a government entity, other entities or combinations thereof. It will be appreciated that the rules, regulations and/or constraints may also have different sources of origins than those listed above for illustration. The buyer acquisition user interface is coupled to at least one retrieval module (such as the management unit described in relation to FIG. 2) that retrieves and display item information from the catalog database.

As a non-limiting example of rules, regulations, and constraints that may affect the landed costs of an item or prohibit a sale of the item, some organizations associated with a prospective buyer may have rules prohibiting acquisitions from specified countries or specified companies. Similarly, a country may have regulations prohibiting the sale of certain types of products to certain destinations. Likewise, a buyer may specify constraints that also impact a prospective acquisition. For example, the buyer may specify a constraint that a supplier of an item of interest must be able to deliver by ground or air transport to the designated destination location because the buyer does not wish to deal with maritime-related fiscal or time costs. It will be appreciated that the above rules, regulations and constraints are for purpose of illustration and that other rules, regulations and constraints are also within the scope of the present disclosure.

Continuing with the discussion of the exemplary embodiment, the buyer acquisition user interface may be configured to receive a user selection of at least one item. An order management unit may be communicatively coupled to the buyer acquisition user interface to add the at least one item to a list and store the list in a database. Each item in the list may include a shipping or source location (e.g., a country, a state, etc.) from where the item will be shipped to a buyer. The order management unit identifies an intermediate sourcing agent associated with a shipping location for each item. The order management unit transmits one or more items in the list to one or more associated intermediate sourcing agents. The intermediate sourcing agent arranges for the fulfillment of an order for at least one item on a list and its delivery to a buyer. The intermediate sourcing agent works on behalf of the retailer/buyer to execute the fulfillment from the supplier—including negotiation, logistics and compliance requirements.

In some embodiments, the system further includes a machine learning module configured to use machine learning to learn to identify items that are not able to be sold in particular countries due to rules, regulations and constraints. In such an embodiment, the system may not display such items in the user interface when the buyer is located in a country unauthorized to receive the item, or the system may display the item in the user interface with a notification that the buyer cannot receive the item in the current location of the buyer.

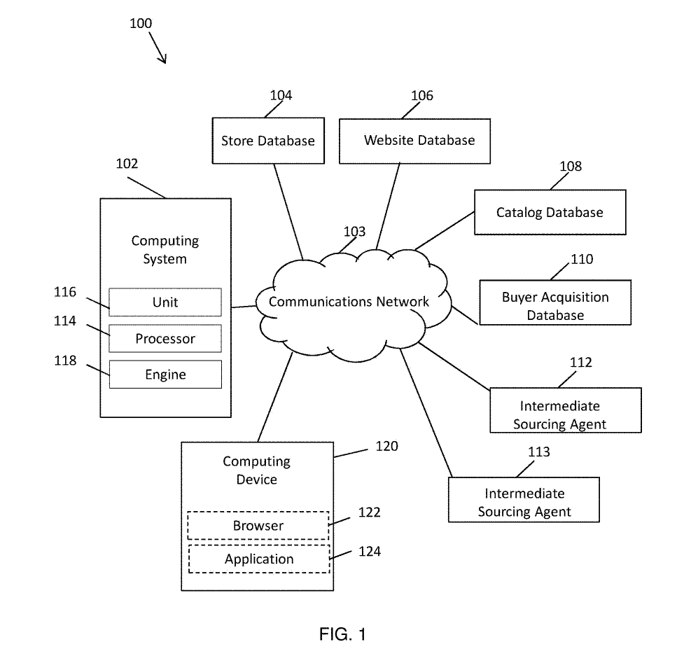

The exemplary system described herein may receive item information and provide estimated landed costs for multiple countries and a large number of items. The system further aggregates item information from predefined websites and databases located globally and provides a global classification to classify items located in regions throughout the world to connect buyers with sellers. The system increases a speed, usability, and efficiency for making purchases throughout the world based on the specific arrangement of computing components such as, but not limited to, those shown in FIGS. 1-11 that are responsible for performing the claimed system and method steps.

FIG. 1 is an exemplary networked environment 100 for distributed acquisitions, in accordance with embodiments of the present disclosure. The environment 100 includes a computing system 102 communicatively coupled, via communications network 103, to at least one store database 104 and/or website database 106, at least one catalog database 108, at least one buyer acquisition database 110, and at least two intermediate sourcing agents 112, 113. The intermediate sourcing agents 112, 113 are located in different geographical locations. The computing system 102 includes at least one processor 114 executing at least one management unit 116 and at least one processor 114 executing a rules engine 118. The at least one management unit 116 may include an ETL management unit, an order management unit, an item management unit, a department management unit, a search management unit, a currency management unit, a user management unit, and/or a list management unit, as described in FIG. 2. The rules engine 118 applies predefined rules to item information to calculate landed costs for an item. As noted above, a landed cost is a more complete representation of the total price of an item once it has arrived at a buyer's door. Although the catalog database 108 and the buyer acquisition database 110 are shown as remote from computing system 102, in alternative embodiments, the catalog database 108 and/or the buyer acquisition database 110 exist within computing system 102.

In an exemplary embodiment, the computing system 102 is communicatively coupled to at least one computing device 120. The computing device 120 may be, for example, a desktop computer or a mobile computing device (i.e., a smartphone). The computing device 120 includes a web browser 122 and/or an application 124 (i.e., a desktop application and/or a mobile application) to enable a user to view and interact with a buyer acquisition website and/or buyer acquisition application via a buyer acquisition user interface.

The communications network 103 can be any network over which information can be transmitted between devices communicatively coupled to the network. For example, the communication network 103 can be the Internet, an intranet, virtual private network (VPN), wide area network (WAN), local area network (LAN), and the like.

FIG. 2 is an exemplary architecture 200 of the computing system 102 for distributed acquisitions, in accordance with an exemplary embodiment. The architecture 200 is broken down into eight management units: an extraction, transformation, and loading (ETL) management unit, an order management unit, an item management unit, a department management unit, a search management unit, a currency management unit, a user management unit, and a list management unit.

The ETL management unit includes at least one processor configured to extract item information (i.e., item data) from one or more source systems 202 in order to store the extracted item information in a catalog database 108. In an exemplary embodiment, source systems 202 include at least a store database (e.g., a database storing item information for items available at stores) and/or a website database (e.g., a database storing item information for items available on a website). In the exemplary embodiment, the at least one processor may include a batch processor 204, a stream processor 206, and/or a feed processor 208. The batch processor 204 obtains item information on a daily basis. The stream processor 206 streams item information. The feed processor 208 obtains a real-time data feed to reflect immediate item changes, such as price changes. The at least one processor transmits the item information to the data cleanup module 210. The data cleanup module 210 normalizes the item information so that the item information is consistent when stored in the catalog database 108.

The item management unit includes an item ingestion queue 212, an item ingestion module 214, and an item management API 216. The data cleanup module 210 transmits the item information to the item ingestion queue 212. In one embodiment, each item in the item information goes into the item ingestion queue 212 to be reviewed by an administrator before going into the catalog database 108. The item ingestion module 214 pulls items from the item ingestion queue 212 and adds the items along with the associated item information into the catalog database 108. More specifically, item information for each item is stored in a file. The item ingestion module 214 imports the file, processes the file, and adds the item to the catalog database 108. The item ingestion module 214 minimizes item duplications and errors. The item management API 216 is coupled to a buyer acquisition user interface 218 to enable administrators to manage items in the item information.

The search management unit includes a search engine 220 and a search API 222. The search engine 220 indexes the item information on a predefined basis (i.e., daily). The search API 222 is coupled to the buyer acquisition user interface 218 to enable users, such as buyers, to search for and view items via the buyer acquisition user interface 218.

The department management unit includes a department API 224. The department API 224 is used to categorize the items into departments and displays the item categorizations in the buyer acquisition user interface 218, enabling users to browse by department. Exemplary departments may include, but are not limited to, clothing, shoes and jewelry, home and kitchen, books, digital music, phones and accessories, automotive parts and accessories, sports and outdoors, tools and home improvement, electronics, and baby.

The currency management unit includes a currency service module 226 and a currency API 228. The currency service module 226 retrieves currency exchange rates from a source and stores the rates in a buyer acquisition database 110. The currency API 228 retrieves the currency exchange rates from the buyer acquisition database 110 for use in calculating landed costs and/or for display in the buyer acquisition user interface 218.

The list management unit includes a list management API 232. The list management API 232 enables users and/or administers to create and manage lists using the buyer acquisition user interface 218. Each list includes one of more items placed in the list by a user using the buyer acquisition user interface 218. The lists are stored in the buyer acquisition database 110.

The user management unit includes a user management API 234. The user management API 234 enables users and/or administers to create and manage user profiles using the buyer acquisition user interface 218.

The order management unit includes an order management API 236, an order management service 238, used to interact with at least two intermediate sourcing agents 240, 242 that are located in different geographical regions, and the buyer acquisition database 110 for storing the lists. The order management API 236 enables users and/or administers to manage lists and orders using the buyer acquisition user interface 218. Once the user confirms an ordering of items in a list using the buyer acquisition user interface 218 (a process that may be thought of as “finalizing the list”), the order management service 238 determines which intermediate sourcing agent 240, 242 receives the order. The intermediate sourcing agent that receives the order is responsible for executing the order pursuant to a market-specific workflow. For example, intermediate sourcing agent X located in country Y may be configured to contact a local supplier or warehouse to prepare and ship the item(s) in the list to the user. In some embodiments, the order management service 238 updates an order and/or shipping status, viewable using the buyer acquisition user interface 218.

If a list includes at least two items that are prepared and shipped by at least two different intermediate sourcing agents, the order management service 238 separates the items by intermediate sourcing agent and sends an individual order to each intermediate sourcing agent. Each individual order includes items associated with the intermediate sourcing agent receiving the order.

The List Management API 232, User Management API 234, Currency API 228, Search API 222, Department API 224, Item Management API 216, and Order Management API 236 are communicatively coupled to the buyer acquisition user interface 218. In some embodiments, the catalog database 108 and/or the buyer acquisition database 110 are MySQL databases and incorporate database servers. In additional embodiments, the catalog database 108 is an Apache Cassandra database management system.

In some embodiments, the prices of the items shown in the buyer acquisition website and/or buyer acquisition application are determined from prices obtained from orders. The prices from the orders are fed to the catalog database 108 and used to populate the prices in the buyer acquisition website and/or buyer acquisition application. In other embodiments, the prices of the items are based on the prices retrieved from the one or more source systems 202. The prices are used as guidance by the sourcing agent to ensure the cost provided by the supplier reflects past business with that supplier and other factors. The ultimate cost extended to the buyer or sourcing agent using the application will be determined in the arrangement set between them specifically.

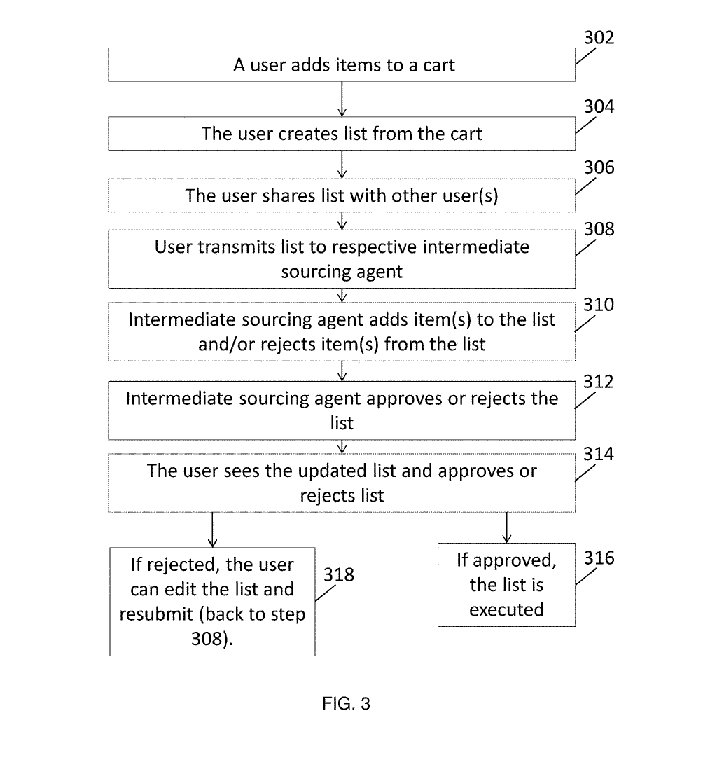

FIG. 3 illustrates a method to create a list of one or more items, as described in FIG. 2, in accordance with embodiments of the present disclosure. In step 302, a user adds items to a cart using a buyer acquisition user interface (e.g., buyer acquisition user interface 218) through which the user interacts with a buyer acquisition application or a buyer acquisition website. In step 304, the user creates a list from the items in the cart. In some embodiments, in step 306, the user can share the list with other users. In step 308, the order management service transmits the list to a respective intermediate sourcing agent. In some embodiments, in step 310, the intermediate sourcing agent can add items to the list and/or reject items from the list.

In step 312, the intermediate sourcing agent approves or rejects the list. In some embodiments, in step 314, the user (i.e., the original list creator) can view the updated list and approve or reject the updated list. In step 316, when the list is approved, an ordering of the items in the list is executed. For example, an administration team and/or the intermediate sourcing agent prepares and ships the items. In step 318, if the list is rejected, the user can edit the list and resubmit the list, returning to step 308.

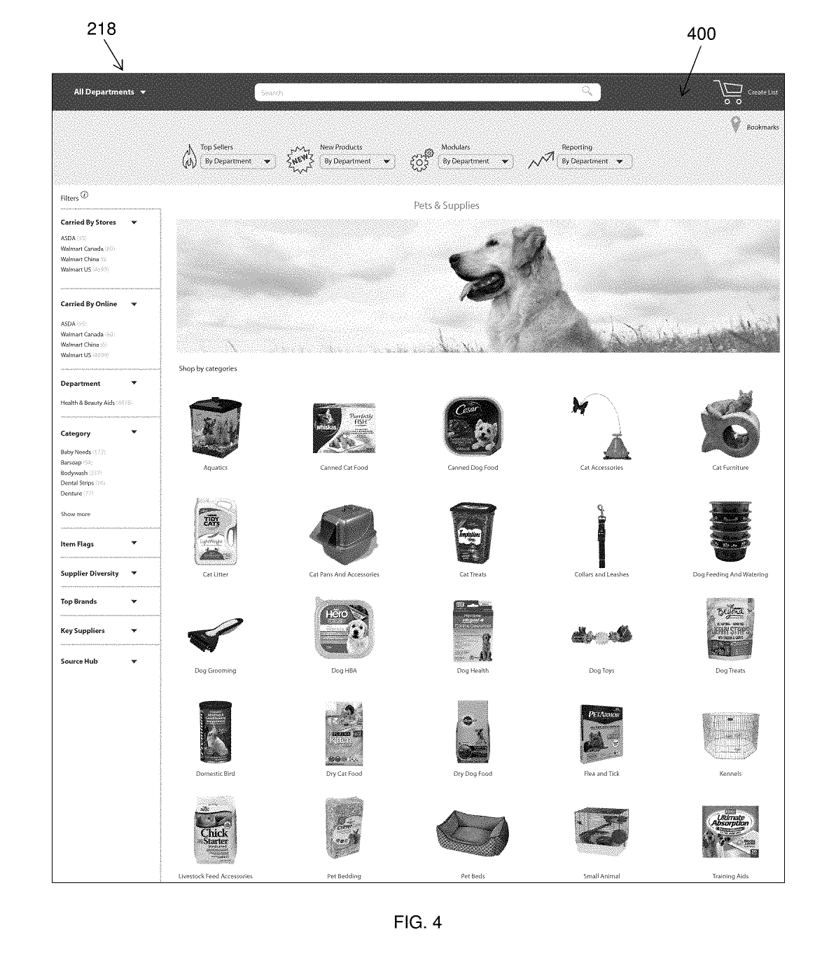

FIG. 4 illustrates a buyer acquisition user interface (i.e., buyer acquisition user interface 218) for a buyer acquisition website 400, in accordance with embodiments of the present disclosure. Using the buyer acquisition user interface, a user can view items stored in a catalog database (i.e., catalog database 108). The user is able to use the buyer acquisition user interface to filter items by, but not limit to, an original buying market, a channel (e.g., online, in-store, shared, online only, exclusive in store), a department (e.g., cosmetics, pets & supplies, etc.), a category (e.g., vitamins, wellness, etc.), item flags (e.g., DSV capable, grain free, etc.), a brand (e.g., 3M®, Equate®, etc.), a supplier (e.g., 3M® company, Abbot®, etc.), an intermediate sourcing agent (e.g., global sourcing Asia, IPL, etc.), supplier diversity (e.g. African American, Asian, Caucasian, Hispanic American, Native America, women owned, etc.), season/buying flags (e.g., winter 2016, back to school 2017, etc.), cost (e.g., cost less than X), brands, and/or tag-on items. In some embodiments, the user can multi-select filters (for example, the user can check one or more boxes to include select filters).

When viewing a results page, the user may view a grid of items based on the selected filters. By default, there may be N items per page, sorted by “Last Updated” date. The user may be able to change the number of items per page. The user may also be able to sort items by, for example, by last update date, annual sales, annual units, first create date, first cost, and/or units/store/week. Each item may include one or more of an image, a cost per unit, a landed cost per unit, a brand name, an item name, or a last update date. A user can select to add an item directly to a list from the results page.

In some embodiments, items carried by two or more markets may be grouped together, displaying lowest cost but enabling the user to see all options. The buyer acquisition user interface enables item comparison to compare multiple items for specified attributes (cost, method of sourcing, items available from supplier). It will be appreciated that other arrangements of results are also within the scope of the present disclosure.

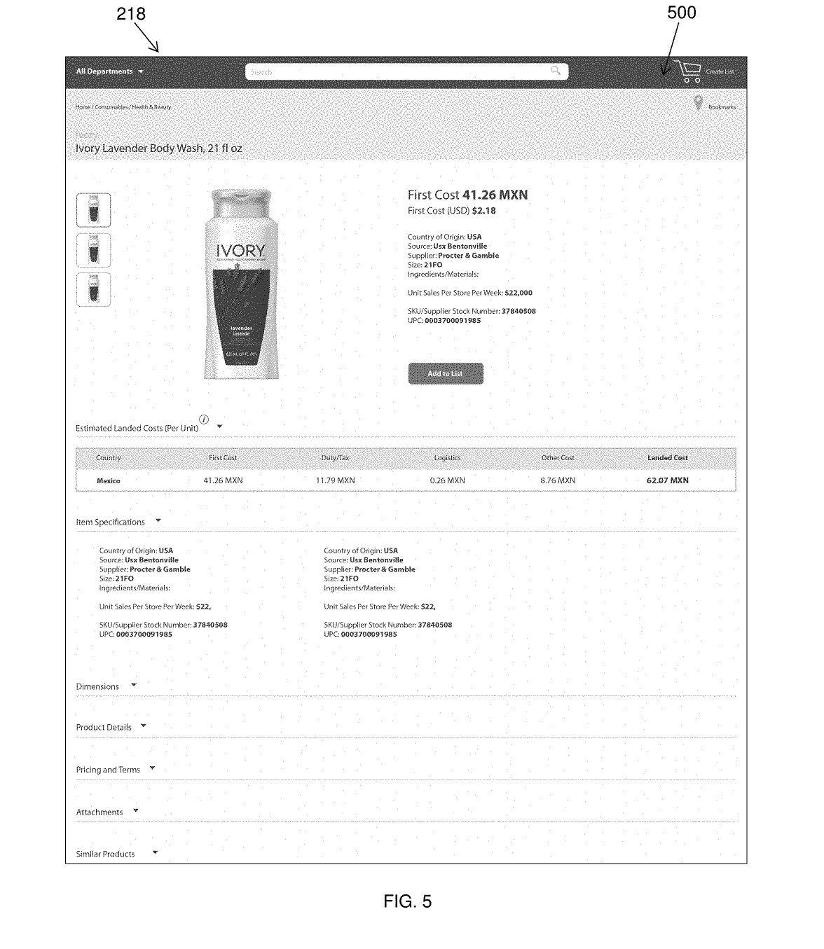

FIG. 5 illustrates a buyer acquisition user interface (e.g., user interface 218) for an exemplary item webpage 500, in accordance with embodiments of the present disclosure. A user views an item summary and details, including one or more of item attributes 502, estimated landed cost details 504 (including conversion to user selected currency), and item sales 506. The user can also view an enlarged item image, including multiple images where available, and items attachments.

The buyer acquisition user interface includes a user-defined landed cost calculator. The user can calculate an estimate using different assumptions. A user can edit the assumptions behind quantity (e.g., based on user input quantity vs. full container assumption), enable use of a factor vs. standard estimated landed cost, and/or save custom assumptions for future items. The user can add the item to a list using a button 508. In some embodiments, items are first added to a cart before being converted to a list. The user can view items (along with their attributes) added to the cart and/or list. The user can leave comments on each item (saved in the list/populated in photo recap). In some embodiments, the user can submit requests directly to intermediate sourcing agents.

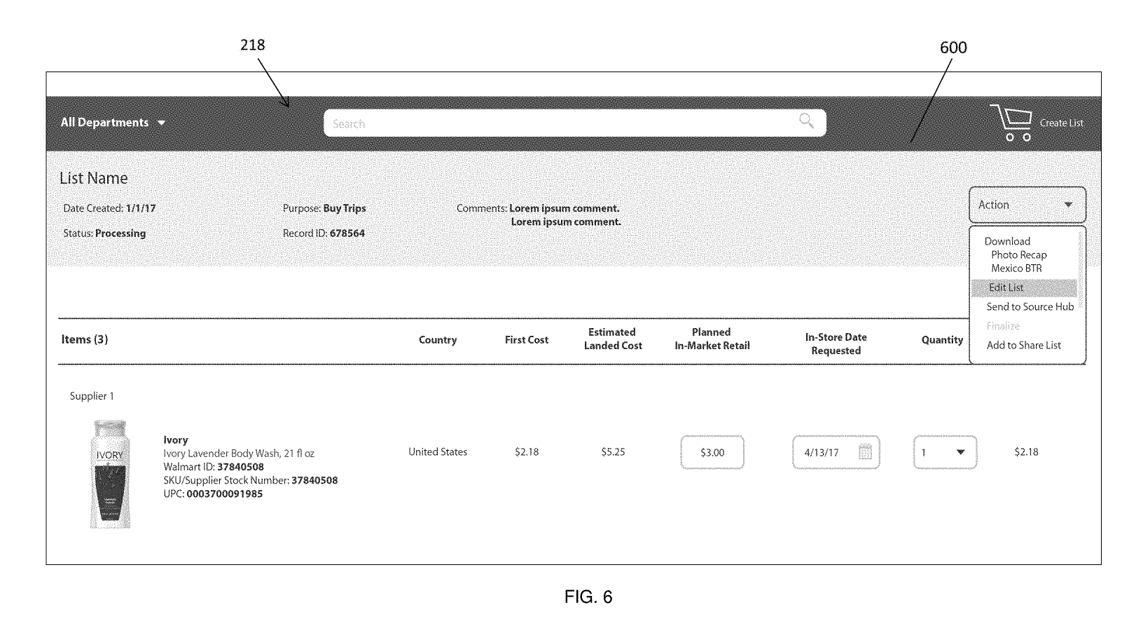

FIG. 6 illustrates a buyer acquisition user interface (i.e., user interface 218) for an exemplary list webpage 600, in accordance with embodiments of the present disclosure. The user can manage and edit the list using list webpage 600. For example, the user can create a list, add and remove items, change quantities, share the list with other users, add comment, upload documents to the list, and view market order output format. In some embodiments, the user finalizes the list before transmitting the list to an intermediate sourcing agent. In an exemplary embodiment, each item in the list includes item information, such as item identifiers (ID, SKU, and/or UPC), country of origin, cost without including landed costs, and with including landed costs. The list may further include additional information, such as planned in-market retail price for the item and in-store date requested for the item.

The exemplary list webpage 600 and/or other pages in the buyer acquisition website and/or the buyer acquisition application further includes customizable market-specific forms available for download For example, United States, Canada, Central America, and Mexico may have market specific formats. The buyer acquisition website and/or the buyer acquisition application may include standard templates differing by market that are available to select and download (for example, Mexico BTR, CAM, item information template, etc.).

In some embodiments, the user can add user comments and/or requests and attachments to an item in the list. For example, the user may upload a request to replenish items or send a certain color of an item. An administrator or intermediate sourcing agent may approve or reject the requests.

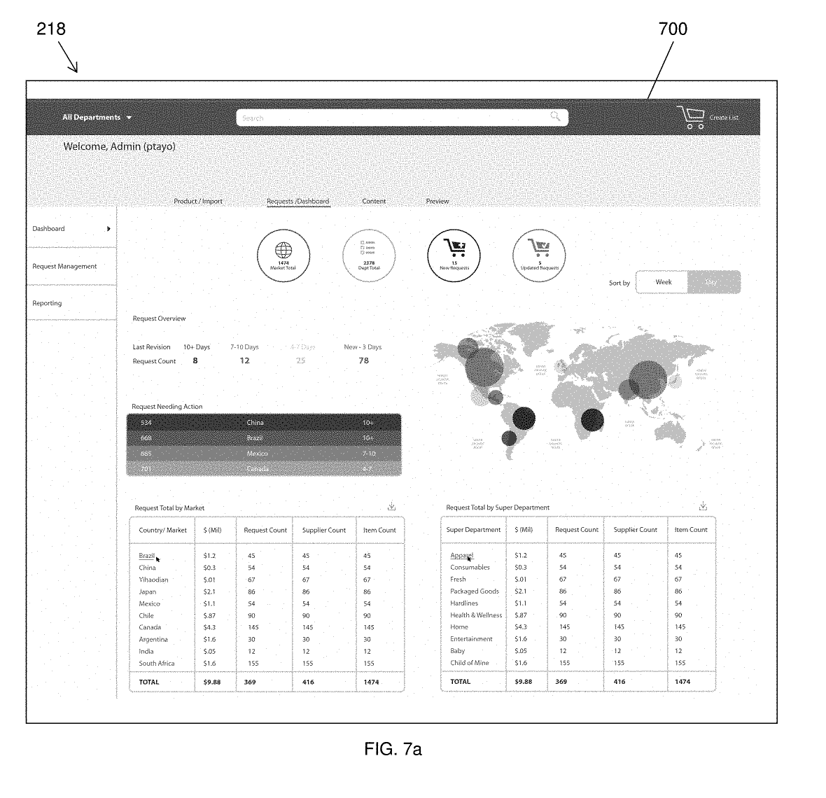

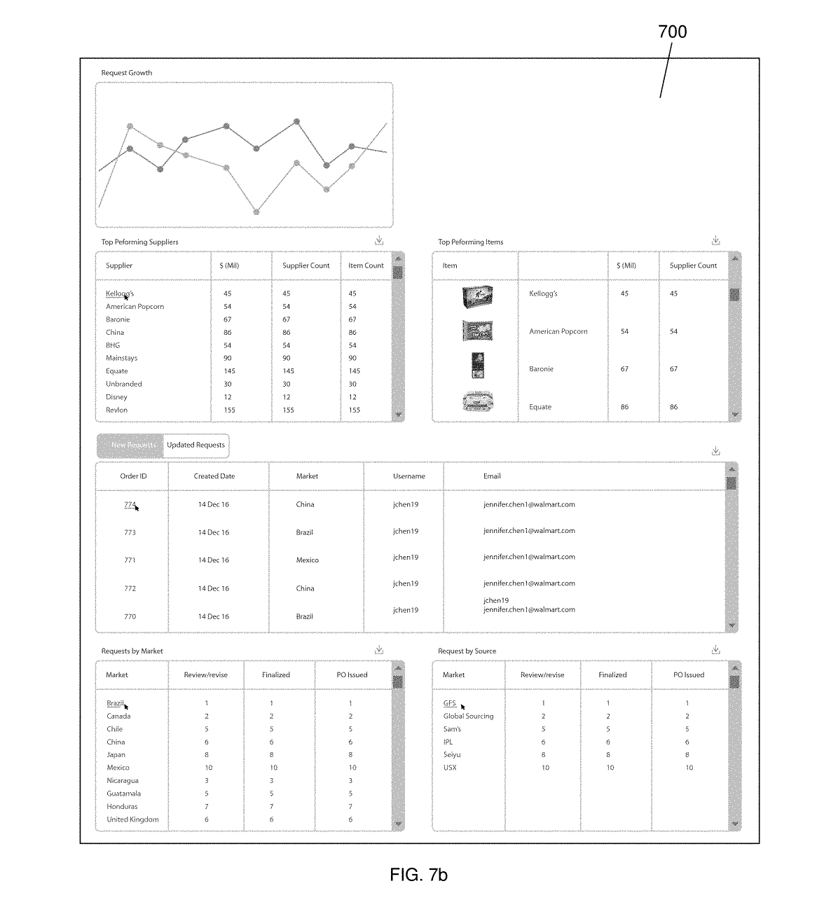

FIGS. 7a and 7b illustrate a buyer acquisition user interface (e.g., buyer acquisition user interface 218) for an administration screen 700, in accordance with embodiments of the present disclosure. The administration screen 700 displays items in a staging environment that is not visible to unauthorized users. The administration screen 700 displays site analytics (including hit rates, conversions, etc.) and user analytics. The user analytics include users' country/domain and usage metrics.

The administration screen 700 and associated webpages enable an administrator to perform a number of functions, including: add items to the catalog database 108, upload item information via a spreadsheet, mark items as staging, active, or an inactive, delete items from the catalog database 108, manage individual items (edit attributes, add items, delete items), add, delete, and/or update images, update HTS codes, duties, and taxes, view global HS numbers, export item information to Excel (can export full catalog or select departments/categories, suppliers/brands, and buying markets, etc.), approve or reject items coming in from the ETL management unit, review items which did not come through the ETL feed (for example, minimum required field not completed or category of item not mapped to hierarchy table), manage filter attributes, such as labels and accepted values, create groupings of items, review and approve duty/tax classification to estimate D/T rates and HS codes on incoming items, manage user roles/privileges, review and approve or reject suppliers to submit content—such as images, setup sheets and other documents, and manage mailing lists & communication based on user account information (for example, based on country, department/category, etc.), add attachments to item pages, manage content, and view exception reporting for items missing key attributes or with calculation errors (for example, errors in landed costs).

In some embodiments, suppliers can submit content, such as images, setup sheets, and other documents. The administrator can use administration screen 700 to review and approve or reject submitted content. In other embodiments, suppliers have access to upload items and/or content directly to catalog database 108 and/or buyer acquisition database 110.

In some embodiment, the administrators and/or intermediate sourcing agents have the same or similar privileges to edit lists, add and/or delete items, edit costs, etc. The user can view created and shared lists in a user account.

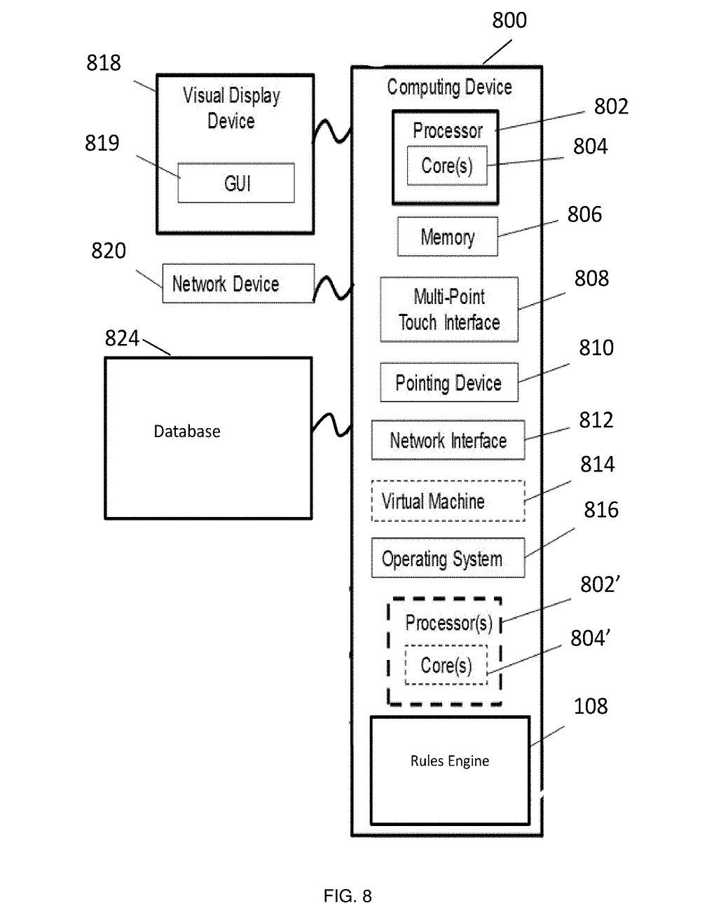

FIG. 8 is a block diagram of an exemplary computing device 800 that can be used to perform one or more steps of the methods provided by exemplary embodiments. In an exemplary embodiment, computing device 800 includes computing system 102. Computing device 800 includes one or more non-transitory computer-readable media for storing one or more computer-executable instructions or software for implementing exemplary embodiments. The non-transitory computer-readable media can include, but are not limited to, one or more varieties of hardware memory, non-transitory tangible media (for example, one or more magnetic storage disks, one or more optical disks, one or more USB flashdrives), and the like. For example, a memory 806 included in computing device 800 can store computer-readable and computer-executable instructions or software for implementing exemplary embodiments. Computing device 800 also includes a processor 802 and an associated core 804, and optionally, one or more additional processor(s) 802′ and associated core(s) 804′ (for example, in the case of computer systems having multiple processors/cores), for executing computer-readable and computer-executable instructions or software stored in memory 806 and other programs for controlling system hardware. Processor 802 and processor(s) 802′ can each be a single core processor or multiple core (804 and 804′) processor. Computing device 800 may include at least one rules engine 118 configured to (1) identify items that are not able to be sold in particular countries due to rules and regulations, and (2) calculate landed costs for an item. Computing device 800 also includes and/or is communicatively coupled to one or more management units, as described in FIG. 2.

Virtualization can be employed in computing device 800 so that infrastructure and resources in the computing device can be shared dynamically. A virtual machine 814 can be provided to handle a process running on multiple processors so that the process appears to be using only one computing resource rather than multiple computing resources. Multiple virtual machines can also be used with one processor.

Memory 806 can include a computer system memory or random access memory, such as DRAM, SRAM, EDO RAM, and the like. Memory 806 can include other varieties of memory as well, or combinations thereof. In some embodiments, a user can interact with computing device 800 through a visual display device 818, such as a touch screen display or computer monitor, which can display one or more user interfaces 819 that can be provided in accordance with exemplary embodiments, for example, the exemplary user interfaces. Visual display device 818 may also display other aspects, elements and/or information or data associated with exemplary embodiments. For example, the visual display device 818 may display a buyer acquisition user interface 218, as described herein. Computing device 800 may include other I/O devices for receiving input from a user, for example, a keyboard or any suitable multi-point touch interface 808, a pointing device 810 (e.g., a pen, stylus, mouse, or trackpad). The keyboard 808 and pointing device 810 may be coupled to visual display device 818. Computing device 800 may include other suitable conventional I/O peripherals.

Computing device 800 can also include one or more databases devices 824, such as a hard-drive, CD-ROM, or other computer readable media, for storing data and computer-readable instructions and/or software, that implements embodiments of the system, as described herein, or portions thereof. Exemplary storage device 824 can also store one or more storage devices for storing any suitable information required to implement exemplary embodiments. Database 824 may include one or more databases as described herein, such as a catalog database 108 and/or a buyer acquisition database 110.

Computing device 800 can include a network interface 812 configured to interface via one or more network devices 820 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 812 can include a built-in network adapter, network interface card, PCMCIA network card, card bus network adapter, wireless network adapter, USB network adapter, modem or any other device suitable for interfacing computing device 800 to any variety of network capable of communication and performing the operations described herein. Moreover, computing device 800 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

Computing device 800 can run any operating system 816, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. In exemplary embodiments, the operating system 816 can be run in native mode or emulated mode. In an exemplary embodiment, the operating system 816 can be run on one or more cloud machine instances.

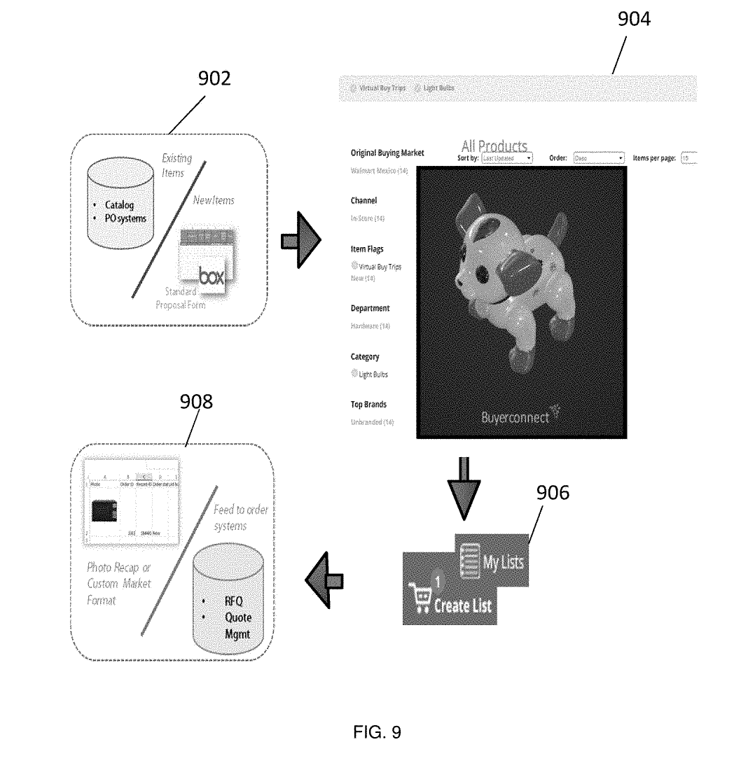

FIG. 9 illustrates a process for creating three dimensional virtual items, in accordance with an exemplary embodiment. The three dimensional virtual items are displayable in the buyer acquisition website and/or the buyer acquisition application via a buyer acquisition user interface.

In 902, the ETL management unit retrieves item information for an item from the catalog database for existing items or a proposal form for new items. A scanner is used to scan the physical item and generate three dimensional virtual images of the item, as shown in 904.

In 904, buyers can select a link in the buyer acquisition website and/or the buyer acquisition application via the buyer acquisition user interface to view the three dimensional virtual image in the buyer acquisition website and/or the buyer acquisition application. Each item in the catalog database can include a three dimensional virtual image of the item that includes a 360 degree rotational view of the virtual item.

In 906, buyers can select items they may want to purchase. A buyer can create a list as described above.

In 908, the list is formatted into a customized arrangement of the item data retrieved from the buyer acquisition website and/or the buyer acquisition application. The format is compatible with one or more management units as described in FIG. 2.

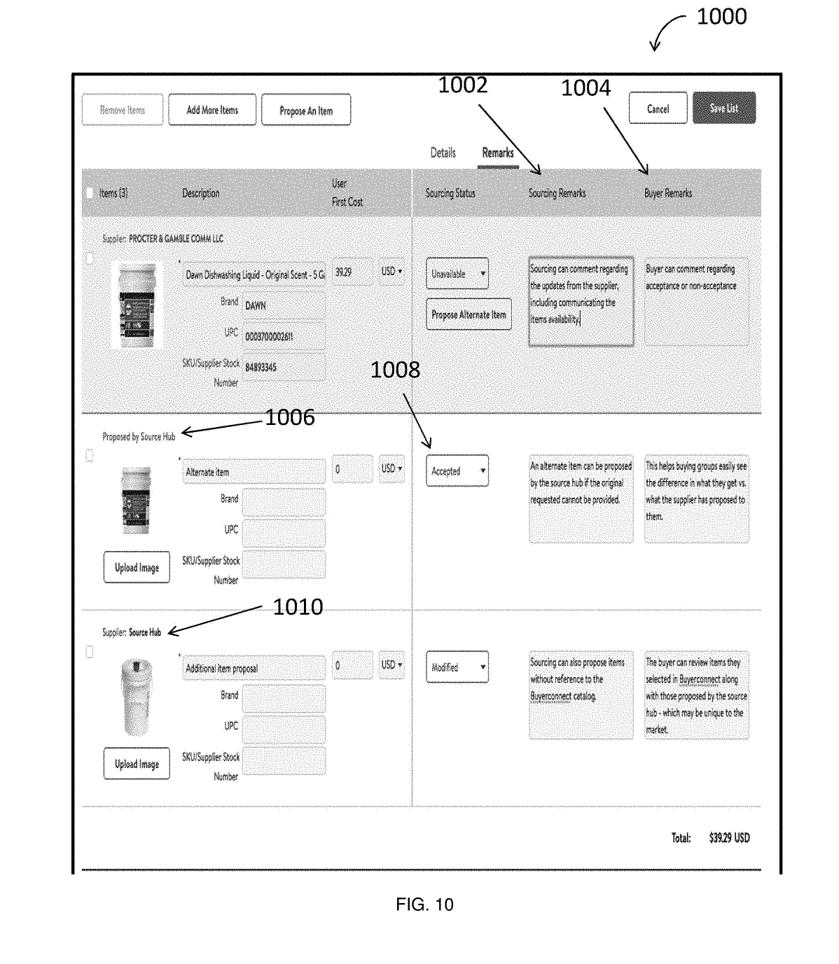

FIG. 10 illustrates a communications interface 1000, in accordance with an exemplary embodiment. The interface 1000 enables intermediate sourcing agents to leave remarks 1002 and buyers to leave remarks 1004 on an item on a list. For example, an intermediate sourcing agent can leave comments regarding item and/or shipping updates from a supplier, including communicating item availability. The buyer can leave comments regarding acceptance or non-acceptance of an item.

When a buyer selects items from the item catalog, the intermediate sourcing agent can view interface 1000 to confirm purchase eligibility and items changes ahead of execution and shipping. In addition, the intermediate sourcing agent can propose an alternate item 1006 if a selected item or a requested item is unavailable. The interface 1000 enables intermediate sourcing agent and buyers to visualize differences in the requested item versus the alternate item. The buyer can then choose to accept the alternate item 1006, for example, using a drop down menu 1008 shown in interface 1000.

The intermediate sourcing agent can also propose an additional item 1010 in addition to the alternate item 1006. The intermediate sourcing agent can propose items without reference to the item catalog. The buyer can review items selected from the item catalog along with the items proposed by the intermediate sourcing agent.

Interface 1000 enables buyers and intermediate sourcing agents to better communicate regarding items in a list and enables better execution with fewer open buyer-seller questions and without requiring an exchange of emails and chats.

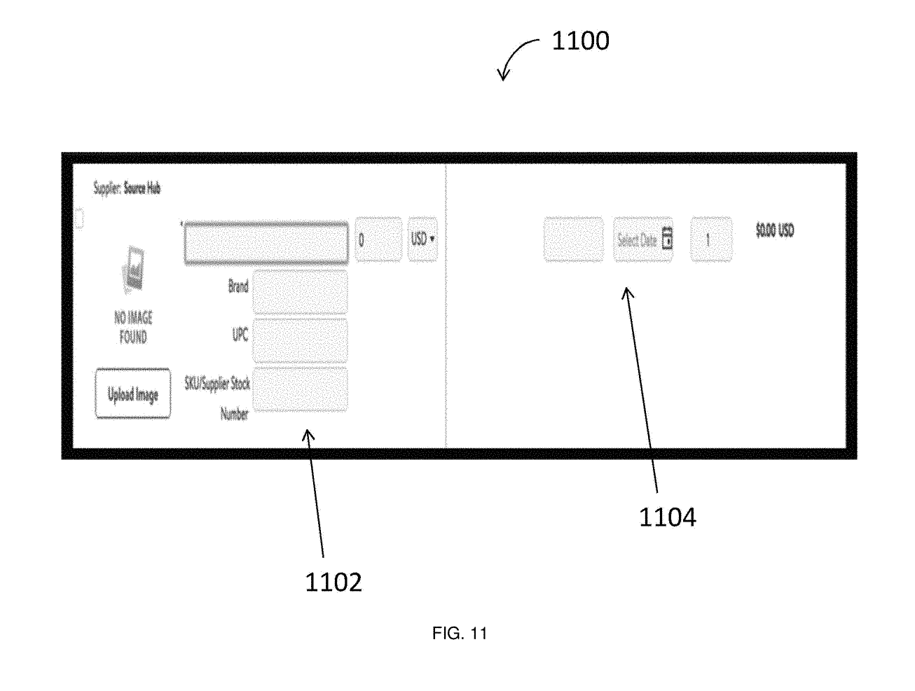

FIG. 11 illustrates an option window 1100 for adding items directly to the data catalog in an exemplary embodiment. Window 1100 enables intermediate sourcing agent to share items with multiple, select users. Window 1100 is a self-service portal for intermediate sourcing agents to add Big Bets, Innovative Wins, or Joint-Buy Items—these are items which have a short timeline for other buyers to participate in and/or involve confidentiality to share (such as items sold on Black Friday)

Window 1100 enables intermediate sourcing agent to create items quickly and directly to be stored in the data catalog and viewed by buyers. The intermediate sourcing agent is able to enter parameters 1102, such as item identifiers, quantity available, and an original price of item, as well as to upload an image of the item that can be displayed on the buyer acquisition website and/or the buyer acquisition application via the buyer acquisition user interface. The intermediate sourcing agent is further able to enter date availability/available quantity 1104.

Specified buyers may receive the items in a list, as shown in FIG. 6 and/or FIG. 10, and the buyer confirms selections of the items.

The following description is presented to enable any person skilled in the art to create and use a computer system configuration and related method and systems for improving access to electronic data. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps can be replaced with a single element, component or step Likewise, a single element, component or step can be replaced with a plurality of elements, components or steps that serve the same purpose. Moreover, while exemplary embodiments have been shown and described with references to particular embodiments thereof, those of ordinary skill in the art will understand that various substitutions and alterations in form and detail can be made therein without departing from the scope of the invention. Further still, other aspects, functions and advantages are also within the scope of the invention.

Exemplary flowcharts are provided herein for illustrative purposes and are non-limiting examples of methods. One of ordinary skill in the art will recognize that exemplary methods can include more or fewer steps than those illustrated in the exemplary flowcharts, and that the steps in the exemplary flowcharts can be performed in a different order than the order shown in the illustrative flowcharts.

We claim:

1. A system for distributed acquisitions, the system comprising:
a catalog database storing item information;
a retrieval module executable by at least one processor, the retrieval module communicatively coupled to a plurality of store websites and store databases located in a plurality of geographical locations, the retrieval module when executed:
obtains item information for a plurality of items from the plurality of store websites and store databases, wherein the item information includes at least an original price of each item of the plurality of items, at least two of the items of the plurality of items originating in different countries, and
stores the item information into the catalog database;
a rules engine configured to apply predefined rules to the item information to calculate landed costs for items delivered to an indicated destination;
a user interface executing on a computing device and communicatively coupled to the rules engine, the user interface configured to:
display filtered item information from the catalog database, wherein the filtered item information includes landed costs for each item determined by the rules engine and is filtered based on applying predefined rules for shipments between a source and receiving country where the predefined rules determine restrictions on where items can sold, bought, or shipped, and
receive a user selection of at least one item of the plurality of items entered into a list;
an order management module communicatively coupled to the user interface, and configured to:
receive the list, wherein the at least one item in the list includes a source of the at least one item,
identify an intermediate sourcing agent associated with the source of the at least one item, and
transmit the list to the intermediate sourcing agent to order the at least one item.

2. The system of claim 1, further comprising a search engine coupled to the catalog database and configured to retrieve item information from the catalog database for display in the user interface.

3. The system of claim 1, wherein the order management module is communicatively coupled to a database configured to store order information.

4. The system of claim 1, wherein the item information also includes information regarding insurance and crating, handling and payment fees.

5. The system of claim 1, wherein the predefined rules includes at least one of rules, regulations and constraints for ordering the at least one item.

6. The system of claim 5, wherein machine learning is used to eliminate items not able to be sold in identified countries due to the at least one of rules, regulations and constraints.

7. The system of claim 1, wherein a user can use the user interface to create, save, edit, and share lists of items.

8. The system of claim 1, wherein the rules engine is configured to apply the predefined rules, regulations and constraints to filter the item information shown on the user interface.

9. The system of claim 1, wherein the item information further includes transportation costs, custom fees, duties, taxes and currency conversion rates based on the indicated destination, a geographic origin of the items and a country of origin of the items.

10. A method for distributed acquisitions, the method comprising:
obtaining, by a retrieval module communicatively coupled to a plurality of store websites and databases located in a plurality of geographical locations, item information for a plurality of items from the store websites and databases, wherein the item information includes at least an original price of each item of the plurality of items and at least two of the items of the plurality of items originate in different countries;
storing, by the retrieval module, the item information into a catalog database;
applying, by a rules engine, predefined rules to the item information to calculate landed costs for items delivered to an indicated destination;
displaying, by a user interface executing on a computing device and communicatively coupled to the rules engine, filtered item information from the catalog database, wherein the filtered item information includes landed costs for each item determined by the rules engine and is filtered based on applying predefined rules for shipments between a source and receiving country where the predefined rules determine restrictions on where items can be sold, bought, or shipped;
receiving, by the user interface, a user selection of at least one item of the plurality of items entered into a list;
receiving, by an order management module communicatively coupled to the user interface, the list from the user interface, wherein the at least one item in the list includes a source of the at least one item;
identifying, by the order management module, an intermediate sourcing agent associated with the source of the at least one item; and
transmitting, by the order management module, the list to the intermediate sourcing agent to order the item.

11. The method of claim 10, further comprising retrieving, by a search engine coupled to the catalog database, item information from the catalog database for display in the user interface.

12. The method of claim 10, wherein the order management module is communicatively coupled to a database configured to store order information.

13. The method of claim 10, wherein the item information also includes information regarding insurance, and crating, handling and payment fees.

14. The method of claim 10, wherein the predefined rules includes at least one of rules, regulations and constraints for ordering the at least one item.

15. The system of claim 14, wherein machine learning is used to eliminate items not able to be sold in identified countries due to the at least one of rules, regulations and constraints.

16. The method of claim 10, wherein a user can use the user interface to create, save, edit, and share lists of items.

17. The method of claim 10, wherein the rules engine is configured to apply the predefined rules, regulations and constraints to filter the item information shown on the user interface.

18. The system of claim 10, wherein the item information further includes transportation costs, custom fees, duties, taxes and currency conversion rates based on the indicated destination, a geographic origin of the items and a country of origin of the items
